(19) United States
(12) Patent Application Publication
(10) Pub. No.: US 2026/0087486 A1
(43) Pub. Date: Mar. 26, 2026

(54) AI CO-PILOT PLATFORM FOR GENERATING COMPUTATIONAL AWARENESS AND AUTONOMOUS OPERATIONAL GUIDANCE

(71) Applicant: RMINT Inc, CARY, NC (US)

(72) Inventor: Balaji Kannaiyan, CARY, NC (US)

(73) Assignee: RMINT Inc, CARY, NC (US)

(21) Appl. No.: 19/397,892

(22) Filed: Nov. 22, 2025

Related U.S. Application Data
(63) Continuation of application No. 18/116,881, filed on Mar. 3, 2023.
(60) Provisional application No. 63/317,664, filed on Mar. 8, 2022.

(51) Int. Cl. G06Q 20/36; G06Q 20/38; G06Q 20/40

(52) U.S. Cl. CPC G06Q 20/363; G06Q 20/389; G06Q 20/401

(57) ABSTRACT

A system and method for enabling autonomous restaurant operations are disclosed. The system is executed by an AI co-pilot server platform comprising a multi-agent AI architecture operating on an Aggregated Domain Intelligence Layer. A Discovery Intelligence Agent interacts with users via a multi-modal interface to generate personalized “Menu Directives.” An Operational Intelligence Agent then orchestrates a suite of specialized, sLLM-powered Task Agents to autonomously generate a complete operational plan. This plan includes a discovered price point, a time-aware schedule, and skill-based execution guidance. The system's intelligence is built and maintained through a continuous train-evaluate-inference loop, employing techniques such as hierarchical fine-tuning of foundational LLMs and Reinforcement Learning from Human Feedback (RLHF). The platform transforms multi-modal culinary content into dynamic, personalized experiences and provides deep audience awareness to creators and restaurants, with content usage metered via a secure attribution system.

### REFERENCE TO RELATED APPLICATIONS

This application is a continuation of U.S. patent application Ser. No. 18/116,881, titled “SYSTEMS AND METHODS OF PERSONALIZING SERVICES ASSOCIATED WITH RESTAURANTS FOR PROVIDING A MARKETPLACE FOR FACILITATING TRANSACTIONS”, filed Mar. 3, 2023, which claims the benefit of U.S. Provisional Ser. No. 63/317,664 , titled “SYSTEM AND METHOD FOR SECURE RECIPE MARKETPLACE AND TRANSACTIONS”, filed Mar. 8, 2022, each of which is incorporated by reference herein in its entirety.

### FIELD OF THE INVENTION

Generally, the present disclosure relates to the field of data processing. More specifically, the present disclosure relates to an artificial intelligence (AI) co-pilot platform for generating computational awareness and autonomous operational guidance.

### BACKGROUND OF THE INVENTION

The distribution of digital content, from literature to culinary recipes, has traditionally followed a static, one-to-many model where the content is inert and unaware of its audience. For instance, when a book is purchased, every reader receives the identical text, regardless of their prior knowledge or the specific interests of the person consuming the content. This static model is inefficient.

A technical problem exists in the lack of a system capable of imbuing digital content with “awareness.” Imagine, for example, giving a book to a personal AI assistant. Before you read it, the AI could first read the book itself and, by comparing its contents to a deep understanding of your existing knowledge and current goals, make intelligent decisions on your behalf. It could not only filter out chapters you already know but could also autonomously plan a personalized consumption path for you, highlighting the most relevant sections to read first and suggesting prerequisite concepts. The present invention solves the technical problem of creating such a system: one that can make content computationally “person-aware” and use that awareness to generate personalized, actionable plans.

A parallel technical problem exists for the restaurant business, which has historically been viewed as a commodity transaction business. The present invention introduces a counterintuitive paradigm shift: transforming the restaurant business into a content-driven business. It creates a new, content-intensive transaction layer on top of the traditional commodity transaction.

Furthermore, just as the internet era required new protocols to meter the flow of data packets across networks for billing and quality of service, the emerging AI era requires a new protocol to meter the flow of content and intelligence as it is personalized, synthesized, and utilized. In a world where AI can dynamically modify and merge content, a robust technical solution is needed to track the provenance of the original content and meter its usage to ensure fair compensation for creators. This lack of a content metering protocol means creators cannot gain deep, computational audience awareness in real-time. The technical challenge has shifted from a 1: Many content distribution model to a Many:1: Many fulfillment paradigm, where AI must synthesize and optimize a single operational plan from a massive volume of disparate user requests.

Therefore, there is a need for an AI co-pilot platform for generating computational awareness and autonomous operational guidance that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a technical solution in the form of an AI Co-Pilot server platform implementing a multi-agent AI architecture. The architecture comprises a Discovery AI Engine and an Operational AI Engine, which are specifically embodied in the advanced architecture as a Discovery Intelligence Agent Hub and an Operational Intelligence Agent Hub that operate upon a central Aggregated Domain Intelligence Layer.

The Discovery AI Engine/Agent Hub is the customer-facing component. Its Reasoning Engine synthesizes Person-Aware, Content-Aware, and Context-Aware intelligence to generate a “Personalized Menu Directive”—a concrete, co-created culinary plan for the user, which includes a predicted customer count derived from multi-modal inputs. The Discovery Agent is responsible for the ‘Many:1’ portion of the Many:1: Many fulfillment paradigm.

The Operational AI Engine/Agent Hub is the restaurant-and creator-facing component responsible for autonomous operational planning. It takes the Menu Directive as input and, through its Reasoning Engine, orchestrates a multi-agent collaboration to perform all subsequent planning functions:
1. Topological Price Discovery: Autonomously discovers an optimized, menu-directive-informed price point by assessing structural risk.
2. Content Synthesis: Retrieves and synthesizes multi-modal execution content.
3. Autonomous Scheduling & Guidance: Creates a time-aware schedule and skill-based task routing for all preparation steps.

These distinct autonomous operational planning functions are bundled and integrated into a single, cohesive Autonomous Standard Operating Procedure (SOP) for a specific meal session or day. This SOP is the final executable output transmitted to the restaurant.

The entire system is architected around a continuous train-evaluate-inference loop, ensuring the underlying Awareness Models that power the agents evolve and improve over time.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram illustrating the AI Co-Pilot's Core Architecture (The “Bridge” Figure), providing a high-level overview of the two-engine model from U.S. patent application Ser. No. 18/116,881(“parent application”), in accordance with some embodiments.

FIG. 2 is a flowchart illustrating the process of Personalized Content Generation via Preference-Based Activation Steering, detailing the inference and learning loop for deep personalization, in accordance with some embodiments.

FIG. 3 is a flowchart illustrating the Topological Price Discovery and Bi-Directional Negotiation Algorithm, showing the multi-step process from Text-to-Text Regression to Latent Space Analysis via the Mapper Algorithm and Persistent Homology for structural risk assessment, in accordance with some embodiments.

FIG. 4 is a flowchart illustrating the algorithm for Autonomous SOP (Standard Operating Procedure) Generation via a Tool-Augmented LLM Approach, in accordance with some embodiments.

FIG. 5 is a diagram illustrating an example of the interactive, multi-modal Time-Aware and Skill-Based KDS Interface, featuring a stream for Real-Time Causal Video Synthesis conditioned on staff skill and operational context, in accordance with some embodiments.

FIG. 6 is a block diagram illustrating the Generative Flow Architecture for Autonomous Operational Synthesis, showing the continuous flow field transformation from the Discovery Agent's intent (input distribution) to the Operational Agent's plan (target distribution), in accordance with some embodiments.

FIG. 7 is a block diagram illustrating the advanced Multi-Layered & Orchestrated AI Co-Pilot Architecture, showing the distinct layers from the Aggregated Data Layer up to the Strategic Orchestration Layer, in accordance with some embodiments.

FIG. 8 is a block diagram illustrating the Hierarchical and Federated AI Model Training Architecture, showing the process of creating hyper-local sLLMs from foundational models, in accordance with some embodiments.

FIG. 9 is a flowchart illustrating the continuous Train-Evaluate-Inference loop for maintaining and evolving the Awareness Models within the architecture, in accordance with some embodiments.

FIG. 10 is a flowchart illustrating the AI-Powered Multi-Modal Content Compression Workflow to generate a Compact Latent Representation (CLR), in accordance with some embodiments.

FIG. 11 is a block diagram illustrating the Distributed Task and Actor Execution Model, showing the distinction between high-level, stateful “Actors” and lightweight, stateless “Tasks” for distributed operations, in accordance with some embodiments.

FIG. 12 is a block diagram illustrating the Governance Layer Architecture, including the Privacy and Guardrail Agents, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features.

Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### I. Foundational Disclosure and Overall System Architecture

This application is a continuation of U.S. patent application Ser. No. 18/116,881 (“parent application”), which is incorporated herein by reference in its entirety. The parent application discloses the foundational architecture and process flow for the Artificial Intelligence (AI) Co-Pilot Platform (as disclosed in FIG. 24 and para [0153] of the parent application). The present disclosure provides further detail on the advanced AI architecture, specific algorithms, and specialized embodiments that enable these foundational functionalities.

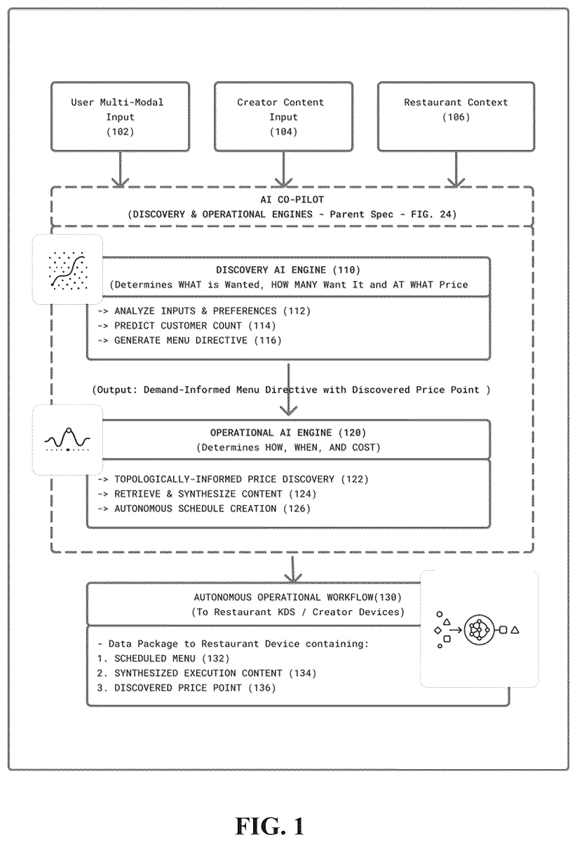

The overall architecture of the AI Co-Pilot Platform (100) is built upon the synergistic operation of two core components (as shown in FIG. 1):
1. The Discovery Artificial Intelligence (AI) Engine/Agent Hub (110): The customer-facing component that analyzes user preferences and contextual data to determine WHAT is wanted, by HOW MANY customers, and at what potential PRICE (as disclosed in FIG. 24 of the parent application). It generates a Demand-Informed Menu Directive.
2. The Operational Artificial Intelligence (AI) Engine/Agent Hub (120): The restaurant-facing component that performs autonomous operational planning, determining HOW and WHEN to execute the directive (as disclosed in para [0078], [0155], and [0180] of the parent application).

The seamless and autonomous flow of data from the Discovery Engine to the Operational Engine is a core technical feature of the platform.

### I.B. System Inputs and Outputs (ref FIG. 1)

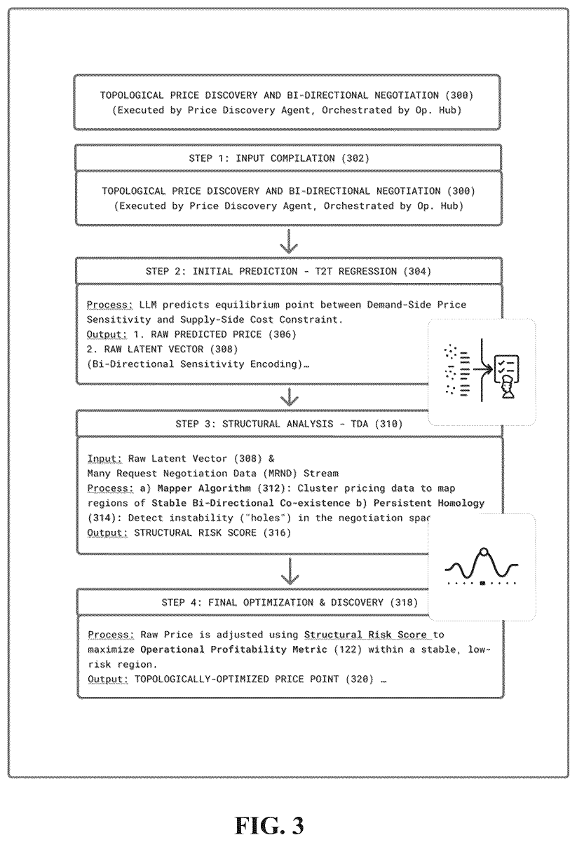

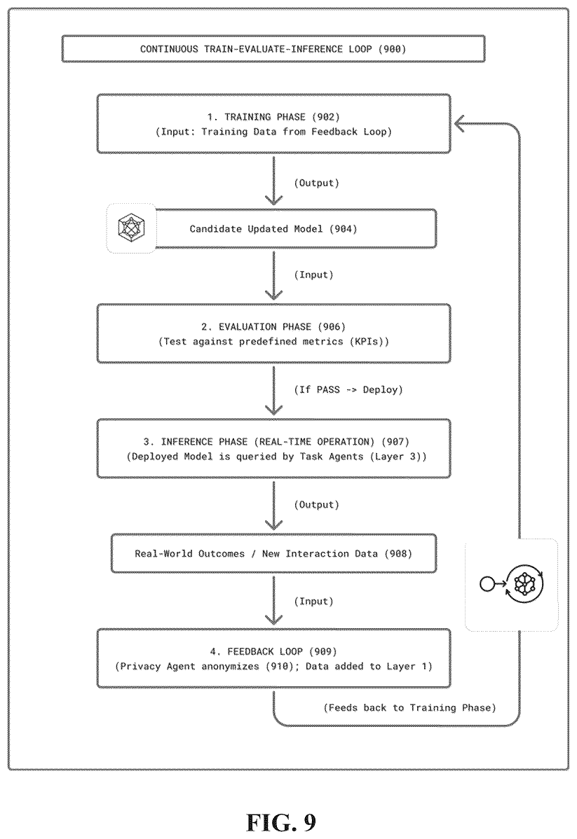

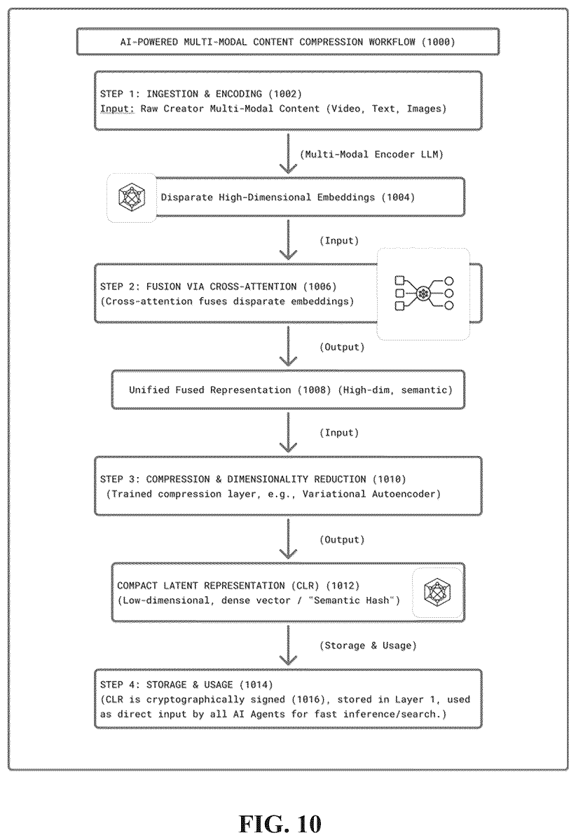

The AI Co-Pilot Platform (100) initiates its intelligence process by receiving and processing three distinct sets of inputs:
1. User Multi-Modal Input (102): Comprises data from users related to their preferences and co-creation intent (as disclosed in FIG. 3A, FIG. 10, and FIG. 18 of the parent application).
2. Creator Content Input (104): Comprises authoritative multi-modal execution content (as disclosed in FIG. 9 and FIG. 18 of the parent application).
3. Restaurant Context (106): Comprises real-time and static operational data, including location, time, and constraints (as disclosed in FIG. 31, and para [0155] and [0172] of the parent application).

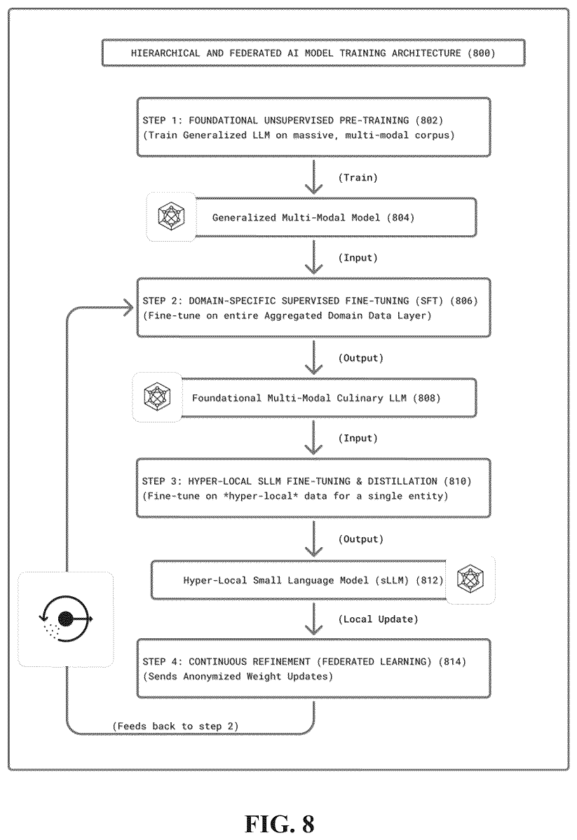

The operation of the Discovery AI Engine (110) is supported by its disclosure in the parent application to analyze user data (as disclosed in FIG. 3A of the parent application) and to determine demand/price points (as disclosed in FIGS. 8, 16A, and 16B, and para [0069] of the parent application), and the output of this stage is explicitly the prediction of a predicted number of customers and a price point (as disclosed by element 2514 of FIG. 25 and element 3112 of FIG. 31 of the parent application).

The operation of the Operational AI Engine (120) is supported by its disclosure to create a scheduled, autonomous operational workflow (as disclosed by element 3122 of FIG. 31 of the parent application) and to perform AI-driven price discovery for profit optimization (as disclosed in para [0155] and [0069] of the parent application).

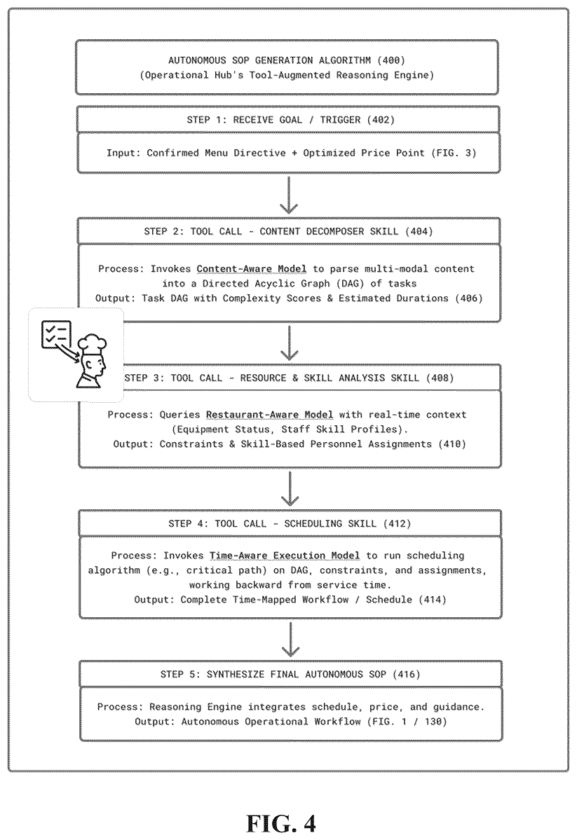

The process flow culminates in the generation and transmission of the Autonomous Operational Workflow (130) to one or more restaurant computing devices. This workflow is a concrete, technical output package comprising: the Scheduled Menu (132) (as disclosed by element 3122 of FIG. 31 of the parent application); the Synthesized Execution Content (134) (as disclosed by element 404 of FIG. 4 of the parent application); and the Discovered Price Point (136) (as disclosed in FIG. 16B of the parent application).

### I.C. Detailed Functional Disclosure of FIG. 1 Blocks

The core functional steps within the Discovery AI Engine (110) and the Operational AI Engine (120) are technical innovations detailed in subsequent sections. Specifically:
1. The mechanism for ANALYZE INPUTS & PREFERENCES (112) and PREDICT CUSTOMER COUNT (114) is detailed in Section IV (Deep Personalization) and Section V (Price Discovery), culminating in the GENERATE MENU DIRECTIVE (116).
2. The function of TOPOLOGICALLY-INFORMED PRICE DISCOVERY (122) is the subject of the detailed algorithm described in Section V (Price Discovery).
3. The steps for RETRIEVE & SYNTHESIZE CONTENT (124) and AUTONOMOUS SCHEDULE CREATION (126) are explained within the Autonomous SOP Generation algorithm in Section VII (Operational Agents).

### I.D. the Ai Co-pilot: an Experience-driven, Multi-agent System

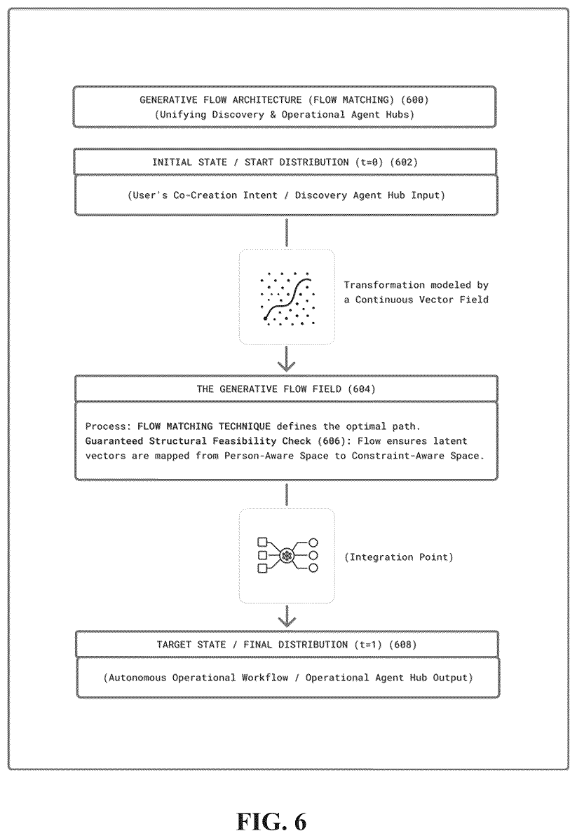

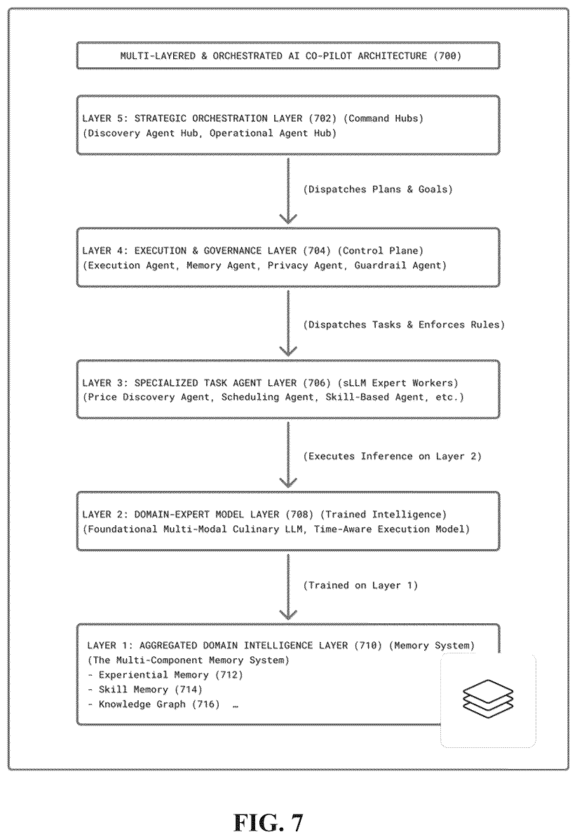

The AI Co-Pilot platform is architected not merely as a sequential pipeline of machine learning models but as an Experience-Driven System capable of continuous, embodied reasoning in a complex, real-world domain. This architecture is fundamentally designed to overcome the limitations of static systems by implementing three core principles:
1. Structured Experience Accumulation: The system's intelligence is built upon a proprietary, multi-component memory system—the Aggregated Domain Intelligence Layer (as shown in element 710 of FIG. 7). This layer actively logs the entire history of its actions, observations, and outcomes (i.e., Experience), providing rich context for all future decisions.
2. Embodied Multi-Step Reasoning: The system uses its Strategic Orchestration Hubs (as shown in element 702 of FIG. 7) to break down complex goals into a structured, multi-step sequence of sub-tasks (as shown in FIG. 4). This process, managed by the Generative Flow Architecture (as shown in FIG. 6), is a form of Embodied Reasoning where the sequence of computational actions directly impacts the physical, real-world environment.
3. Continuous Learning from Action Outcomes: The platform employs a specialized Train-Evaluate-Inference Loop (as shown in FIG. 9) to continuously measure the difference between its predicted outcomes and the real-world results. This mechanism utilizes the accumulated Experience for Reinforcement Learning from Human Feedback (RLHF).

### II. Generative Flow Architecture: The AI Co-Pilot as a Generative Flow Model for Autonomous Operational Synthesis (Ref FIG. 6)

The synergistic operation of the Discovery AI Engine (110) and the Operational AI Engine (120) is implemented and governed by a Generative Flow Architecture (600) (as shown in FIG. 6). This architecture unifies the platform's core process under a single, mathematically-guided generative path using Flow Matching techniques.

The architecture models the entire transformation from a user's high-level intent to a final operational plan as a continuous vector field, defining a controllable and high-fidelity pathway between two distributions: the Initial State/Start Distribution (t=0) (602) (user intent) and the Target State/Final Distribution (t=1) (608) (resource-constrained plan).

The Generative Flow Field (604) is the continuous vector field learned by the Flow Matching model. This approach provides a Guaranteed Structural Feasibility Check (606), which is a novel technical advantage: the model learns to map latent vectors from the Discovery Agent's Person-Aware Latent Space (demand/preference) to the Operational Agent's Constraint-Aware Latent Space (cost/time/resource limits), thereby providing structural validation that drastically reduces conflicts.

### II. B. Multi-layered and Orchestrated AI Co-pilot Architecture (ref FIG. 7)

The Generative Flow is executed upon a sophisticated, multi-layered and Artificial Intelligence (AI) co-pilot architecture (700) (as shown in FIG. 7). The architecture comprises five distinct layers:
1. LAYER 5: Strategic Orchestration Layer (702): The Command Hubs (Discovery/Operational Hubs).
2. LAYER 4: Execution & Governance Layer (704): The Control Plane (Execution, Memory, Privacy, Guardrail Agents).
3. LAYER 3: Specialized Task Agent Layer (706): The small language model (sLLM) Expert Workers (Price Discovery, Scheduling, Skill-Based Agents).
4. LAYER 2: Domain-Expert Model Layer (708): The Trained Intelligence (Foundational large language model (LLM), Time-Aware Model).
5. LAYER 1: Aggregated Domain Intelligence Layer (710): The Multi-Component Memory System (Experiential Memory, Skill Memory, Knowledge Graph).

### III. Core Intelligence and Awareness Architecture (Ref FIG. 7 & FIG. 10)

### III. A. Layer 1: The Aggregated Domain Intelligence Layer-A Multi-Component Memory System (Ref FIG. 7)

The foundation of the AI Co-Pilot's intelligence is its Aggregated Domain Intelligence Layer (710). This layer is implemented as a sophisticated, multi-component memory system, and comprises specialized memory types:
1. Experiential Memory (The “Memory Stream”) (712): This component functions as the system's long-term, time-ordered memory of all operational Experience. This stream logs every interaction, decision, and outcome, providing the rich, contextual data needed for Reinforcement Learning from Human Feedback (RLHF).
2. Skill Memory (Procedural “How-To” Knowledge) (714): This component stores the procedural knowledge of the system. It is the technical foundation for the Autonomous SOP Generation capability and is populated by authoritative, multi-modal Creator Content Input (104).
3. Knowledge Graph (Declarative “What-Is” Knowledge) (716): This component stores structured, factual information about the culinary domain as a graph database containing entities and their relationships.

The data within this multi-component memory is accessed by agents via a specialized Multi-Component Retrieval Orchestrator (MCRO). The MCRO is responsible for performing Hybrid Retrieval, combining dense vector search (on Compact Latent Representations (CLRs) and latent vectors) with lexical search (on procedural knowledge). Crucially, the MCRO utilizes a fusion function designed to satisfy the properties of Monotonicity, Homogeneity, and Boundedness to ensure the ranked list of contextual data is mathematically stable, unbiased by scale, and directly relevant for downstream large language model (LLM) reasoning.

### III. B. AI-Powered Multi-Modal Content Compression and Representation (Ref FIG. 10)

The platform's efficiency is underpinned by processing raw creator content into an AI-native data format called a Compact Latent Representation (CLR) (1012) via the AI-Powered Multi-Modal Content Compression Workflow (1000) (as shown in FIG. 10).
1. Ingestion, Encoding, and Fusion (1002, 1006): A specialized multi-modal encoder, configured as a Unified Multi-Modal Intelligence Layer, processes and fuses disparate multi-modal streams (1004) using cross-attention mechanisms into a single, unified representation (1008).
2. Compression and Attribution (1010, 1016): The unified representation (1008) is passed through a compression layer to generate the final CLR (1012)—a low-dimensional, dense vector. This CLR is configured to be cryptographically signed (1016) by the creator to provide a verifiable and immutable link for attribution.

### III. C. Layer 2: the Domain-expert Model Layer (as Shown in FIG. 7)

Built upon Layer 1 is Layer 2: The Domain-Expert Model Layer (708). This layer contains the foundational machine learning models fine-tuned on the multi-component memory, including the Foundational Multi-Modal Culinary large language model (LLM) and the Time-Aware Execution Model.

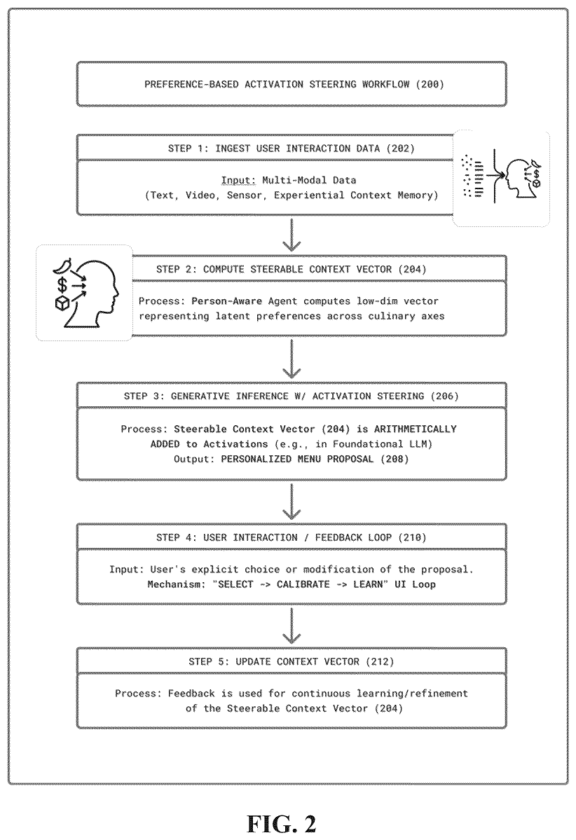

### IV. The Discovery Intelligence Agent: Deep Personalization and Co-Creation (as shown in FIG. 2)

### IV. A. Unified Multi-Modal Input Processing (as shown in FIG. 2, Step 1)

The Discovery Intelligence Agent Hub (110) processes the User Multi-Modal Input (102) (as shown by element 202 of FIG. 2) using the principles of a Unified Multi-Modal Intelligence Layer. This specialized architecture fuses disparate multi-modal streams early to create a single, semantically rich representation of the user's current co-creation intent, which includes context from the Experiential Memory Context. This fusion process allows the Discovery Agent to query the Experiential Memory (712) for past conversation context and preferences. This retrieval utilizes the Multi-Component Retrieval Orchestrator (MCRO) with a fusion function that prioritizes conversational turns based on the Reciprocal Rank Fusion (RRF) principles. This ensures the retrieved context is monotonically ranked for relevance and satisfies the Boundedness property, which limits the influence of context to the current user and the relevant local restaurant environment, preventing distortion from overly general or temporally distant data.

### IV. B. Deep Personalization via Preference-Based Activation Steering (as shown in FIG. 2)

The core technical method for personalization is Preference-Based Activation Steering (200) (as shown in FIG. 2):
1. Compute Steerable Context Vector (204): A Person-Aware Agent computes a low-dimensional steerable context vector representing the user's core preferences across multiple culinary axes. The vector is continuously refined based on past interactions logged in the Experiential Memory (712).
2. Generative Inference with Activation Steering (206): The Steerable Context Vector (204) is arithmetically added to the activations of the Foundational Multi-Modal Culinary LLM (708) in Layer 2. This Activation Steering guides the LLM's generative process in real-time towards outputs that are highly aligned with the specific user's latent preferences.
3. User interaction/feedback loop (210): User's explicit choice or modification of the proposal.
4. Update context vector (212): Feedback is used for continuous learning/refinement of the steerable context vector.

### IV. C. Predictive Analysis and Menu Directive Generation

The Discovery Agent Hub also executes the PREDICT CUSTOMER COUNT (114) function (as shown in FIG. 1). This process analyzes the user's latent preferences against market data from the Knowledge Graph (716) and Experiential Memory (712) to generate a predicted number of customers who share the detected affinity for the proposed menu items. This analysis relies on a proprietary Many Request Negotiation Data (MRND) Stream, which is a record of all previously processed Demand-Informed Menu Directives specific to that menu item combination, session, and local restaurant. This MRND Stream is the technical foundation for the Many:1: Many paradigm, capturing the aggregated sentiment and price elasticity from a large volume of user requests.

### V. Topological Price Discovery and Bi-directional Negotiation (as Shown in FIG. 3)

The Operational AI Engine Hub (120) autonomously discovers a price point by executing the Topological Price Discovery and Bi-Directional Negotiation Algorithm (300) (as shown in FIG. 3). This process finds the optimal, structurally stable intersection between the customer's price sensitivity (demand) and the restaurant's required profitability (supply).

### V.A. Initial Prediction via Text-to-text Regression (as Shown in FIG. 3, Steps 1 & 2)

STEP 1 is input compilation (302). The Price Discovery Agent (Layer 3) executes STEP 2: Initial Prediction via Text-to-Text Regression (T2T-R) (304). A specialized LLM fine-tuned for T2T-R predicts the equilibrium point between the Demand-Side Price Sensitivity and Supply-Side Cost Constraint, generating the Raw Predicted Price (306) and the Raw Latent Vector (308).

### V.B. Structural Stability Analysis via Topological Data Analysis (as Shown in FIG. 3, Step 3)

The core innovation is the use of Topological Data Analysis (TDA) (310) applied to the Raw Latent Vector (308). This TDA process specifically addresses the challenge of AI negotiation, where the Discovery Agent's inferred user price ceiling and the Operational Agent's required profit floor create a constrained negotiation window. The Many Request Negotiation Data (MRND) Stream (as described in paragraph [0069] of the present application) provides the empirical basis for this analysis.

The Price Discovery Agent executes Step 3: Structural Analysis—TDA (310):
1. Mapper Algorithm (312): Performs Topological Clustering to map regions of Stable Bi-Directional Co-existence. This clustering utilizes the MRND Stream to accurately define the boundaries of stable demand for that specific menu and location.
2. Persistent Homology (314): Computes homological features to identify structural instability (“holes”), generating a Structural Risk Score (316).

### V.C. Final Price Optimization and Discovered Price Point (as shown in FIG. 3, Step 4)

The Operational AI Engine Hub autonomously calculates the final price point (318) by adjusting the Raw Predicted Price (306) using the Structural Risk Score (316) to maximize the Operational Profitability Metric. The final output is the Topologically-Optimized Price Point (320).

### VI. Content Compression and Representation (as Shown in FIG. 10)

Content is processed into a Compact Latent Representation (CLR) (1012) via the AI-Powered Multi-Modal Content Compression Workflow (1000). This process uses a Unified Multi-Modal Intelligence Layer for encoding and fusion, and the final CLR is cryptographically signed (1016) by the creator to provide a verifiable and immutable link for attribution.

### VII. Operational Intelligence Agent: Autonomous SOP Generation (as shown in FIG. 4)

### VII. A. Task Decomposition and Synthesis (as shown in FIG. 4, Steps 1 & 2)

STEP 1 is receive goal/trigger (402). The Operational Hub's Reasoning Engine acts as a Tool-Augmented Large Language Model to perform Autonomous SOP Generation Algorithm (400). It invokes the Content Decomposer Skill (404) to analyze the CLR (1012) and create a Directed Acyclic Graph (DAG) of discrete preparation tasks (406).

### VII. B. Resource-constrained Planning (as Shown in FIG. 4, Steps 3 & 4)

The process invokes the Resource & Skill Analysis Skill (408) to obtain Constraints & Skill-Based Personnel Assignments (410). This leads to Skill-Based Task Routing, which assigns tasks based on matching the complexity score to personnel skill level. The Scheduling Skill (412) then creates the final Time-Mapped Workflow/Schedule (414). STEP 5 is synthesize final autonomous SOP (416).

### VII. C. Synthesis and Final Output (as shown in FIG. 4, Step 5)

The final Autonomous Operational Workflow (SOP) (130) is generated. The SOP is organized as a hierarchically synthesized product that groups tasks into logical operational units (e.g., “Protein Station,” “Sauté”), adhering to the principles of a Synthetic Structured Description.

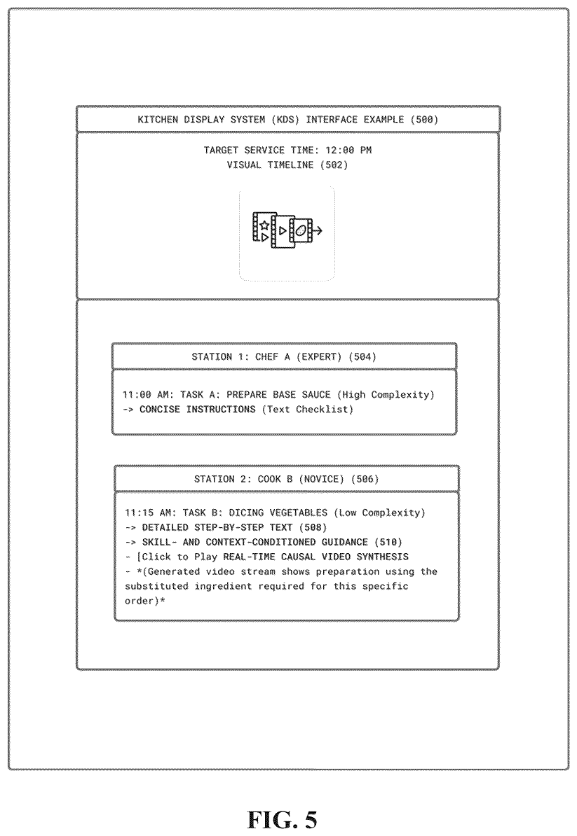

### VIII. Guided Execution: Real-Time Personalization and Delivery (as shown in FIG. 5)

### VIII. A. Skill-Based Guidance Generation

The Autonomous Operational Workflow (130) is delivered to the Kitchen display system (KDS) (500) (as shown in FIG. 5) as Personalized Guidance. Guidance is tailored to the staff member's skill profile (Expert vs. Novice). The KDS interface 500 includes a visual timeline (502), station 1: chef A (expert) (504), and station 2: cook B (novice) (506). The station 1: chef A (expert) (504) includes task A: Prepare base sauce including concise instruction. The station 2: cook B (novice) (506) includes task B: dicing vegetables including detailed step-by-step text (508) and skill-and context-conditioned guidance.

### VIII. B. Real-time Causal Video Synthesis

The system uses Real-Time Causal Video Synthesis (510). A specialized Real-Time Causal Video Synthesis Agent powered by an Autoregressive Diffusion Transformer Model autonomously synthesizes a video sequence (as shown in element 510 of FIG. 5). The synthesis is conditioned on the task, skill profile, and real-time operational context (e.g., ingredient variant) to provide Just-in-Time, Synthesized Visual Guidance.

### IX. AI Model Training and Lifecycle (as shown in FIG. 8 & FIG. 9)

### IX. A. Hierarchical and Federated Ai Model Training Architecture (as Shown in FIG. 8)

The system uses a Hierarchical and Federated AI Model Training Architecture (800) to create a suite of specialized models. This multi-stage process begins with Foundational Unsupervised Pre-training (802), which then feeds into Domain-Specific Supervised Fine-Tuning (SFT) (806). The output of the SFT is further refined via Hyper-Local small language model (sLLM) Fine-Tuning & Distillation (810) to create the restaurant-specific model, which is finally maintained through Continuous Refinement (Federated Learning) (814).

### IX. B. the Continuous Train-evaluate-inference Lifecycle (as Shown in FIG. 9)

The Machine Learning Operations (MLOps) lifecycle is governed by the Continuous Train-Evaluate-Inference Loop (900).
1. Evaluation Phase (906): The model is tested against a proprietary, Multi-Axis Operational Alignment (MAOA) framework to ensure alignment with multifaceted goals: Structural Integrity (SI), Operational Utility (OU), Prediction Accuracy (PA), and Preference Alignment (P-A). The PA metric specifically evaluates the success of the Bi-Directional Negotiation by measuring how closely the Topologically-Optimized Price Point (320) aligns with both the realized customer demand (as captured by the MRND Stream) and the realized operational profitability over time, going beyond simple forecast error.
2. Feedback Loop (909): New Experience data is cleaned, anonymized by the Privacy Agent (1202), and added to the Aggregated Domain Intelligence Layer (710).

### IX. C. Preference Alignment via Reinforcement Learning from Human Feedback (RLHF)

The MAOA metrics are the technical foundation for the Reward Model used in RLHF. The Reward Model outputs a score used as a reward signal to fine-tune the Task Agent's small language models (sLLMs), aligning their generative behavior with the desired goals.

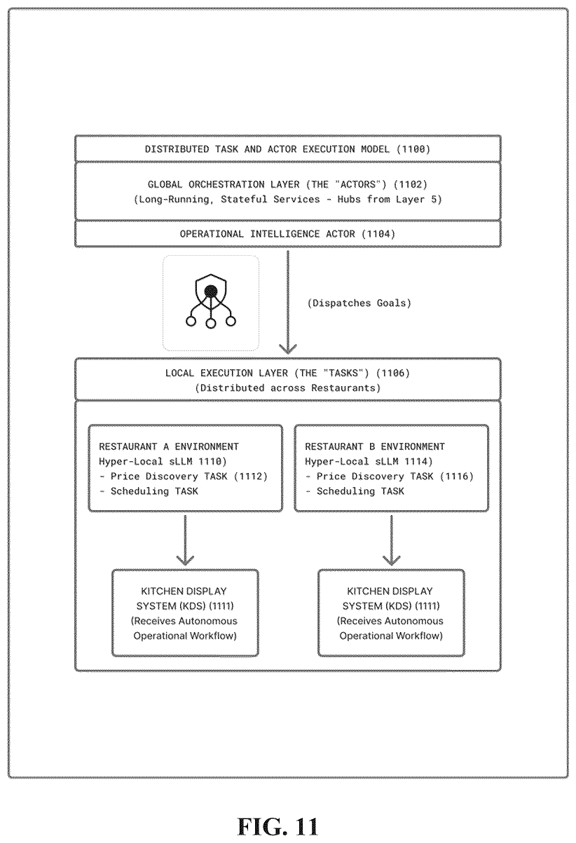

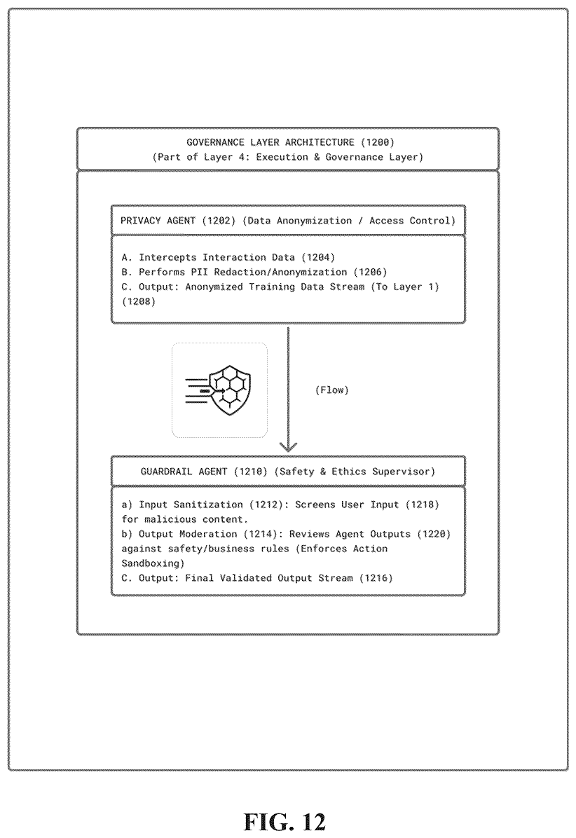

### X. Distributed Operations and Governance (as shown in FIG. 11 & FIG. 12)

### X.A. Distributed Task and Actor Execution Model (as Shown in FIG. 11)

The system enables Distributed Autonomous Restaurant Operations through the Distributed Task and Actor Execution Model (1100), divided into a Global Orchestration Layer (The “Actors”) (1102) and a Local Execution Layer (The “Tasks”) (1106). Tasks execute using the restaurant's Hyper-Local sLLM (812).

The Local Execution Layer (1106) is where the lightweight Tasks (e.g., Price Discovery TASK, Scheduling TASK) are instantiated. The completion of these Tasks generates the final Autonomous Operational Workflow (130), which is delivered to the local Kitchen Display System (KDS) (1111), providing the staff with the actionable, personalized execution plan.

### X.B. the Governance Layer Architecture (1200) (as Shown in FIG. 12)

The Governance Layer Architecture (1200) Acts As the System-wide “control Plane.”
1. Privacy Agent (1202): Performs Personally Identifiable Information (PII) Redaction/Anonymization (1206) and utilizes the principles of Synthetic Structured Descriptions to generate an Anonymized Training Data Stream (1208).
2. Guardrail Agent (1210): This agent acts as a safety and ethics supervisor for the entire platform. It performs Input Sanitization (1212) and Output Moderation (1214), including Action Sandboxing for high-risk decisions. Furthermore, the Guardrail Agent supervises the Multi-Component Retrieval Orchestrator (MCRO) to ensure that the contextual data retrieved for the planning agents satisfies the Homogeneity and Boundedness properties. By doing so, the Guardrail Agent ensures the retrieved context does not inflate or distort its contribution to the final planning output, preventing the downstream LLMs from hallucinating or generating unstable, high-risk plans based on skewed data rankings.

What is claimed is:

1. A computer-implemented method executed by an artificial intelligence (AI) co-pilot server platform, the method for enabling autonomous restaurant operations by computationally transforming user-defined culinary co-creation requests into a scheduled, priced, and actionable operational workflow, the method comprising:
by a Discovery Engine:
a. receiving user input data, the user input data comprising user preference information for multi-modal culinary content;
b. analyzing the received user input data using one or more machine learning models to determine structured user preference characteristics and a predicted number of customers for specific multi-modal culinary content; and
c. generating, based on the determined structured user preference characteristics and the predicted number of customers, a demand-informed menu directive for a target restaurant; by an Operational Engine:
d. retrieving one or more multi-modal content elements from a content database, wherein the one or more content elements are computationally linked to items in the generated menu directive;
e. autonomously discovering, based on the predicted number of customers and an analysis of operational metrics, a menu-directive-informed price point determined to optimize an operational profitability metric; and
f. autonomously creating, based on a generated data package of multi-modal execution content and contextual data, a schedule for the target restaurant;
by the AI co-pilot server platform:
g. transmitting the generated data package, the created schedule, and the determined price point, said transmitted data together comprising an autonomous operational workflow, to one or more restaurant computing devices; and
h. recording, in a database, a transaction record when creator-sourced content is included in the autonomous operational workflow, wherein the transaction record identifies a source of the creator-sourced content to create a data trail for metering said content usage.

2. The method of claim 1, wherein the Discovery Engine is embodied as a Discovery Intelligence Agent Hub and the Operational Engine is embodied as an Operational Intelligence Agent Hub, the Hubs being configured to orchestrate one or more specialized Task Agents of a multi-agent AI architecture.

3. The method of claim 2, wherein the retrieving in step (d) comprises:
the Operational Intelligence Agent Hub querying an Aggregated Domain Intelligence Layer, said layer comprising a multi-component memory system including at least a Skill Memory for storing procedural knowledge and an Experiential Memory for storing time-ordered events; and
the Operational Intelligence Agent Hub receiving said multi-modal content elements from the Aggregated Domain Intelligence Layer in response to the query, wherein said query and retrieval are executed by a Multi-Component Retrieval Orchestrator (MCRO) that utilizes a Hybrid Retrieval fusion function that is mathematically constrained to satisfy the properties of Monotonicity, Homogeneity, and Boundedness to ensure context stability.

4. The method of claim 2, wherein the retrieving one or more multi-modal content elements is performed by utilizing a Compact Latent Representation (CLR) of the content, the method further comprising:
by the AI co-pilot server platform, prior to storing the creator content, processing the multi-modal recipe execution content using a multi-modal encoder to generate the CLR, wherein the CLR is a low-dimensional vector representation of the multi-modal recipe execution content.

5. The method of claim 2, wherein the generating of the demand-informed menu directive by the Discovery Intelligence Agent Hub comprises using preference-based activation steering, the method further comprising:
arithmetically adding a steerable context vector derived from the user's multi-modal interaction data to the activations of a foundational language model; and
generating the menu directive based on the generative process of the language model as steered by the context vector.

6. The method of claim 2, wherein the autonomously discovering the price point by the Operational Intelligence Agent Hub comprises performing a Topologically-Informed Price Optimization process, said process comprising:
i) processing a structured textual prompt via an LLM configured for Text-to-Text Regression to generate a predicted price point and a corresponding high-dimensional latent vector encoding Bi-Directional Sensitivity;
ii) performing Topological Data Analysis (TDA) on the latent vector, utilizing at least one of a Mapper Algorithm or Persistent Homology to extract homological features representative of the structural risk of the predicted price; and
iii) autonomously calculating the final price point by adjusting the predicted price based on the extracted homological features to minimize the structural risk and optimize the operational profitability metric.

7. The method of claim 2, wherein the autonomously creating the schedule by the Operational Intelligence Agent Hub comprises performing Skill-Based Task Routing, the method further comprising:
i) computationally decomposing the multi-modal content elements into a Directed Acyclic Graph (DAG) of discrete preparation tasks, each task assigned a complexity score; and
ii) computationally assigning each discrete task in the DAG to a specific kitchen staff member based on matching the task's complexity score to the staff member's skill profile and synthesizing the scheduled operational workflow into a hierarchically organized Autonomous Standard Operating Procedure (SOP), the SOP reflecting a Synthetic Structured Description of the preparation process.

8. The method of claim 7, wherein the analyzing and autonomous creating steps are part of a continuous Train-Evaluate-Inference Loop, the method further comprising:
in an evaluation phase, measuring the performance of the autonomous operational workflow against a Multi-Axis Operational Alignment (MAOA) framework, the framework comprising at least Structural Integrity (SI) and Preference Alignment (P-A) metrics; and
using the metrics as a reward signal to fine-tune the Task Agents via Reinforcement Learning from Human Feedback (RLHF).

9. The method of claim 7, wherein the autonomous operational workflow includes personalized execution guidance comprising a Real-Time Causal Video Synthesis stream, the method further comprising:
autonomously synthesizing a video sequence by a Real-Time Causal Video Synthesis Agent, said agent powered by an Autoregressive Diffusion Transformer Model, wherein the synthesis is conditioned on the skill profile of the assigned staff member and the real-time operational context of the restaurant to generate a unique, skill-specific, and context-specific visual instruction for a discrete preparation task.

10. The method of claim 2, wherein the Discovery Intelligence Agent Hub and the Operational Intelligence Agent Hub are unified under a single Generative Flow Architecture, the method further comprising:
modeling the transformation from the user input data to the autonomously created schedule as a continuous flow field using a Flow Matching technique; and
thereby utilizing the Flow Matching technique to define a continuous transformation between the Discovery Agent's Person-Aware Latent Space and the Operational Agent's Constraint-Aware Latent Space, ensuring the autonomously created schedule is structurally feasible for the target restaurant.

11. A computer-implemented artificial intelligence (AI) Co-Pilot server system for enabling autonomous restaurant operations by computationally transforming user-defined culinary co-creation requests into a scheduled, priced, and actionable operational workflow, the system comprising:
a. a Multi-Modal Data Ingestion Layer configured to receive heterogeneous data streams, including User Multi-Modal Input and Creator Content Input;
b. an Aggregated Domain Intelligence Layer comprising a non-transitory memory storing a multi-component memory system including:
i. an Experiential Memory for storing time-ordered operational experience data; and
ii. a Skill Memory storing Compact Latent Representations (CLRs) of multi-modal execution content;
c. a Deep Learning Processing Infrastructure comprising a plurality of computing devices including one or more Graphics Processing Units (GPUs) or specialized Tensor Processing Units (TPUs), the infrastructure configured to execute a multi-agent AI architecture, the architecture including:
i. a Model Training Sub-System configured to perform a hierarchical fine-tuning process to generate a Foundational Multi-Modal Culinary LLM and a plurality of specialized, Hyper-Local small language models (sLLMs); and
ii. a Distributed Orchestration Sub-System configured to dispatch specialized tasks to the Hyper-Local sLLMs executing on distributed Local Execution Layers; and
d. an Operational Intelligence Agent Hub executing on the processing infrastructure, the Hub being configured to execute a generative flow field, said field defining a continuous transformation between a Discovery Agent's Person-Aware Latent Space and an Operational Agent's Constraint-Aware Latent Space to autonomously discover a topologically-optimized price point and create a schedule based on the execution of the multi-agent AI architecture.

12. The system of claim 11, wherein the Deep Learning Processing Infrastructure is further configured such that the Discovery Engine is embodied as a Discovery Intelligence Agent Hub and the Operational Engine is embodied as an Operational Intelligence Agent Hub, the Hubs being configured to orchestrate one or more specialized Task Agents of a multi-agent AI architecture.

13. The system of claim 12, wherein the processing device is further configured such that the retrieving comprises:
the Operational Intelligence Agent Hub querying an Aggregated Domain Intelligence Layer, said layer comprising a multi-component memory system including at least a Skill Memory for storing procedural knowledge and an Experiential Memory for storing time-ordered events; and
the retrieval is executed by a Multi-Component Retrieval Orchestrator (MCRO) that utilizes a Hybrid Retrieval fusion function that is mathematically constrained to satisfy the properties of Monotonicity, Homogeneity, and Boundedness to ensure context stability.

14. The system of claim 12, wherein the Deep Learning Processing Infrastructure is further configured to retrieve one or more multi-modal content elements by utilizing a Compact Latent Representation (CLR), the CLR being a low-dimensional vector generated by a multi-modal encoder of the system.

15. The system of claim 12, wherein the Deep Learning Processing Infrastructure is configured to generate the menu directive using preference-based activation steering by arithmetically adding a steerable context vector derived from the user's multi-modal interaction data to the activations of a foundational language model.

16. The system of claim 12, wherein the Distributed Orchestration Sub-System is configured to autonomously discover the price point by executing a Topologically-Informed Price Optimization process, the process including: utilizing the Deep Learning Processing Infrastructure to perform Topological Data Analysis (TDA) on a latent vector encoding Bi-Directional Sensitivity.

17. The system of claim 12, wherein the Distributed Orchestration Sub-System is configured to autonomously create the schedule by coordinating a plurality of specialized Task Agents to perform Skill-Based Task Routing and synthesizing the scheduled operational workflow into a hierarchically organized Autonomous Standard Operating Procedure (SOP), the SOP reflecting a Synthetic Structured Description of the preparation process.

18. The system of claim 17, wherein the Model Training Sub-System is configured to operate the system using a continuous Train-Evaluate-Inference Loop and to measure performance against a Multi-Axis Operational Alignment (MAOA) framework for use in Reinforcement Learning from Human Feedback (RLHF).

19. The system of claim 17, wherein the Distributed Orchestration Sub-System is configured to provide personalized execution guidance comprising a Real-Time Causal Video Synthesis stream by autonomously synthesizing a video sequence using an Autoregressive Diffusion Transformer Model conditioned on the staff member's skill profile.

20. The system of claim 12, wherein the Distributed Orchestration Sub-System is configured to unify the Discovery Intelligence Agent Hub and the Operational Intelligence Agent Hub under a single Generative Flow Architecture by modeling the transformation from user input data to the schedule as a continuous flow field using a Flow Matching technique, defining a continuous transformation between the Person-Aware Latent Space and the Constraint-Aware Latent Space.
